(19) United States
(12) Patent Application Publication
(10) Pub. No.: US 2026/0285278 A1
(43) Pub. Date: Sep. 24, 2026

(54) Integrated Anti-Tamper Air Brake Chamber with Electrical Actuation and Control

(71) Applicant: Harold Ishebabi, Burnaby (CA)

(72) Inventor: Harold Ishebabi, Burnaby (CA)

(21) Appl. No.: 19/087,511

(22) Filed: Mar. 22, 2025

(51) Int. Cl. B60T 13/68; B60T 7/16

(52) U.S. Cl. CPC B60T 13/683; B60T 7/16

(57) ABSTRACT

A device for air brake chamber and air disc brake actuator preventing tampering with brake immobilization functionality and preventing brake release, caging and going off-route without authorization by integrating digital control on the chamber.

### CROSS-REFERENCE TO RELATED APPLICATION

This application claims priority to, and the benefit of, U.S. Provisional Application 63/569,131 (“Integrated Anti-Tamper Air Brake Chamber with Electrical Actuation and Control”), filed on Mar. 23, 2024 the entire contents of which are incorporated herein by reference.

### DETAILED DESCRIPTION OF THE DRAWINGS

The detailed description set forth below in connection with the appended drawings is intended as a description of illustrative embodiments of an integrated anti-tampering air brake chamber with electrical actuation and control in accordance with the present invention and is not intended to represent the only forms in which the present invention may be implemented or utilized. The description sets forth the features of the present invention in connection with the illustrated embodiments. It is to be understood, however, that the same or equivalent functions and structures may be accomplished by different embodiments that are also intended to be encompassed within the spirit and scope of the present invention.

In accordance with the present invention, a brake chamber incorporates mechanisms for blocking air flow to the spring brake side, for venting air out of the spring brake side, and for blocking access to the caging mechanism. These mechanisms are constructed to be an integral part of the chamber, for instance, by mounting them inside the housing. The chamber itself is of any type, including double-diaphragm style or piston style for both drum and disc type brakes.

These mechanisms are digitally controlled through an authorization module. A preferred embodiment is a computing device with a non-volatile storage that contains authorization credentials for drivers or towing tractors. A sensor module provides location and time information that may be tied to the credentials to allow granting access at designated time and location.

In some embodiments, the electronic control components may be distributed such that some are integrated in the chambers, and some are external. This configuration may be desired in installations consisting of several anti-tampering chambers on one vehicle. The communications between externally located components and integrated components may be encrypted to prevent tampering with control messages.

Integrated components have a chamber-integrated power source independent from external power. This prevents tampering by cutting the electric supply. Integrated components are preferentially configured to engage their protection mechanisms when external power is unexpectedly lost. In an exemplary embodiment, this configuration is achieved by arranging the computing device to measure the presence of external power supply whose absence triggers lock down.

The function of the inlet mechanism is to prevent disengaging the parking brake through the normal driving operation unless authorization is granted.

The inlet mechanism is preferentially a ball valve to minimize need for electric energy. Other mechanisms that do not require constant electric power to hold one or the other position, for instance, a double solenoid valve, are also preferred.

The function of the venting mechanism is to re-engage the parking brake. In an exemplary embodiment, the authorization module tracks a pre-authorized route. Upon detection of route deviation, the authorization module causes the venting valves to open when safe to do so. This is a preferred configuration for simplicity; however, it is also possible to configure the module to cause the service brake to engage.

In this exemplary embodiment, there are two venting valves. One is configured to vent to the outside atmosphere through holes on the chamber casing. While these holes can be concealed, it is possible for an actor to sabotage them, disabling the venting. Therefore, a second valve is configured to connect the spring side to the service side. This is a backup valve that preferentially is connected to a check valve to prevent air from flowing back to the spring side.

When opened, and service brakes are not applied, air from the spring side will flow through the service delivery port and out to the exhaust port of the relay valve. Sabotaging the relay exhaust port is impractical since it will prevent the service brakes from releasing.

The authorization module may be configured to open either valve in any order. In some embodiments, these valves are separate normally closed solenoid valves. In other embodiments, the inlet valve may be configured to vent in one position, and allow air to pressurize if in a second position.

The function of the caging mechanism is to block access by preventing the caging (relief) bolt from being inserted. There are brake chamber designs with integrated relief bolts. In those designs, the caging mechanism can be constructed to prevent the integrated relief bolt from rotating.

In either case, caging is permitted only after the authorization is obtained, and either the authorization is entered through a dedicated input device, or is automatically fetched from an upstream software system, for instance, a fleet management system.

In accordance with the exemplary embodiment, a conical spindle is constructed to block the hole when the normally extended solenoid is off. The freely rotating conical spindle prevents a sabotage tool such as a drill from gripping, preventing a hole to be drilled through.

This integration protects the locking and venting mechanisms by leveraging the strength of the parking spring. The high tension is a natural deterrent. Tamper attempts carry a significant risk of bodily injury.

The digital control makes this invention scalable by allowing the protection systems to couple to logistics software.

### FIELD

The invention relates generally to air brake systems for vehicles, particularly to an improved device for air brake chamber and air disc brake actuator for securing heavy duty trailers used in road transportation. It lies within the classification code B60R 25/08 and B6OR25/102 which incorporate fittings including brakes or brake systems for preventing or indicating unauthorised use or theft of vehicles. The invention relates to incorporating a digital authorization module within the chamber or the actuator, which causes an integrated electrical control module to prevent disengaging the parking spring through normal vehicle operations, or to prevent disengaging through the caging process, or to prevent the trailer from going off-route by engaging the parking spring without driver intervention. Therefore the invention incorporates anti-tamper features in the brake chamber construction and operation that prevent anyone from compromising, tampering with or removing the immobilization brake function capability.

### STATE OF THE ART

U.S. Pat. No. 9108605B1 Security air brake locking system discloses an air brake security locking system that retains semi-trailers in a fixed position to prevent theft and is connected to an air brake line of the semi-trailer. The system includes a battery-powered valve which isolates air lines within the braking system, a locked control box to secure and protect a user interface, a wireless remote actuation device is also utilized to activate the system from a distance preventing movement and possible theft.

U.S. Pat. No. 95,053,92B2 Air brake lock and assembly discloses how to help prevent air brake actuation knobs from being actuated serving as a theft-prevention device that mounts over the air brake knobs on the dash of a semi-truck cab so the brake will remain locked, and the truck and trailer will remain immobile.

U.S. Pat. No. 86,025,06B2 Air brake vehicle locking device and system includes a main body having a pair of internal channels capable of connecting to a vehicle air line, a valve interposed between the internal channels for controlling the flow of air, and a control unit for regulating the operation of the valve.

U.S. Pat. No. 6,007,159A discloses a parking brake lock-in key switch system for a truck or bus brake system with two parking brake lock-in valves, one in the air line piping between the primary air tank and the push pull double check valve and the second between the secondary air tank and the push pull double check valve.

EP3444155B1 (Haldex Brake Products) discloses an electronically controlled trailer brake unit and trailer brake system. GB2546254 discloses a vehicle immobilizer system consisting of a vehicle braking system with a lockable valve for holding the spring brakes on to prevent theft of the trailer.

Examples of other security systems are included in WO2009/046512, WO2005/115810, US2005/0062344 and WO01/94130. Disclosures in the last two of these citations disclose trailer locking devices to prevent unauthorized movement or theft by venting compressed air from the parking line to prevent brake release, via a controller unit, control valve and power unit inside the housing.

In EP2928734 and EP2066536 the braking system incorporates a bistable electromechanically switchable current surge valve in the fluid connection line to the actuators.

GB2417764 discloses a means for removal of fluid pressure from the spring actuator, while WO2024/042141 Trailer brake control system discloses an anti-tow or anti-theft system whereas EP3481685 discloses a spring brake control assembly and a movable immobilizer valve to move fluid to a lower pressure zone where the connections are relatively easily accessible and hence may be tampered with or destroyed by unwanted intrusion.

There are also prior art systems based on GSM and/or GPS hardware including US2015217727 which discloses an embedded security system installed on the trailer. The system can be part of a refrigeration system or standalone and can track trailer movement. WO2024/042141 applies biometric PIN identifiers as an alternative to muti-digit PIN codes to control the brakes on a trailer and alert the driver to unauthorized use.

DE102017118529B4 Electronically controlled trailer brake control unit and trailer brake system and DE102017118529.1A 2017 Aug. 14 disclose an electronically controlled trailer brake control structural unit in which an electronically controlled modulator valve device and a spring brake valve device so that the spring brake pressure generated by the spring brake valve device on the one hand and the modulator valve device controlled operating brake pressure on the other are fed to an anti-compound valve. There is a “release function”; “emergency brake function”; “regulated spring-loaded emergency brake function”; “emergency brake valve actuation prevention” function as well as several other functions that include an immobilization function. Activation of the immobilizer can be done, for example, via a smartphone by the user if he detects a theft of the trailer. Also possible is a precautionary activation by the driver to prevent theft when stopping the trailer. In a corresponding manner, a deactivation of the immobilizer, with which then the movement of the trailer is made possible again. The activation and deactivation may require an authentication, for example by inputting a pin or by performing a predetermined activation sequence such as the operation of the ignition key and the service brake pedal. Ensuring such a prevention of a movement of the trailer is hereinafter also subsumed under an “immobilization function”. Prior art reference is also made to DE 10 2011 053 529 B4. DE 10 2012 101 871 B4. DE 10 2013 100 537 A1. WO 2011/003491 A1 and DE 10 2013 100 538 B4.

DE 10 2009 031 785 A1 discloses a pneumatic brake system for a trailer which has an EBS modulator. The EBS modulator is devised as a structural unit, in which electromagnetically controllable valves and an electronic control device are integrated. A manual actuation unit arranged at a distance from the EBS modulator has a manually operable parking valve and a manually operable release valve.

DE 10 2015 116 317 A1 relates to a brake system of a towing vehicle and discloses a spring brake valve device with ventilation control via solenoid valves. Alternatively, a solenoid valve may also be integrated in the housing of the spring brake valve device. It is stimulated in DE 10 2015 116 317 A1.

DE 10 2006 036 748 A1 discloses an electrically controlled brake system of a towing vehicle with a unit modulator controlled by an external electronic control unit. The output signal of the modulator is connected via an overload protection valve or anti-compound valve with spring-loaded chambers of spring brakes.

DE102017118529B4 also cites a robust list of prior art, focusing on electronically controlled trailer braking where some also contain immobilization devices and functions. These include: DE3522183C11985-06-211989-08-31Graubremse Gmbh Brake system for vehicles with spring loaded brake cylinders; EP1188634A22000-09-142002-03-20WABCO GmbH &amp; Co. OHG Trailer brake valve for trailer vehicles with electronic brake control and increased security of the parked trailer; DE102005019479B32005-04-272007-01-18 Haldex Brake Products Gmbh Trailer brake valve for use in a motor vehicle-trailer which has a release valve, control valve with positions such as lifting, lowering, driving and stopping, and an overflow valve integrally arranged in the housing of a relay valve; DE102006036748A1 2006-08-052008-02-07 Wabco Gmbh Electrically controlled brake system; DE102007053764B42007-11-122009-08-20 Haldex Brake Products Gmbh Brake system for a trailer of a motor vehicle; DE102009031785A12009-07-062011-01-13 Wabco Gmbh Pneumatic brake system for a trailer and brake control modulator; GB2492124A2011-06-222012-12-26Haldex Brake Products Ltd Vehicle braking system having an electrically operable emergency braking override valve; DE102007053765B42007-11-122013-03-21 Haldex Brake Products Gmbh Manually actuatable valve for a trailer brake system; DE102012101871B42012-03-062013-12-12 Haldex Brake Products Gmbh Parking brake valve device and pneumatic trailer air brake system; DE102011053529B42011-09-122014-06-26 Haldex Brake Products Gmbh Valve assembly for a trailer brake system; DE102013100537A12013-01-182014-07-24 Haldex Brake Products Gmbh Valve device for a compressed air system of a trailer of a commercial vehicle; EP2821262A22013-07-012015-01-07 Haldex Brake Products GmbH Electric/electronic-pneumatic-interface module; DE102013100538B42013-01-182016-06-02 Haldex Brake Products Gmbh Compressed air system of a trailer of a commercial vehicle; DE102015116317A12015-09-282017-03-30 Knorr-Bremse Systeme für Nutzfahrzeuge GmbH Electro-pneumatic parking brake device of a vehicle with a further control circuit There are also several prior art citations toDE10139757A12000-09-142002-05-29 Wabco Gmbh & Co Ohg Trailer brake valve for trailer vehicles with electronic brake control and enhanced security of the parked trailer; DE102007047691A12007-10-052009-04-09 Wabco Gmbh Electro-pneumatic parking brake modulator for controlling a parking brake function of brakes of a trailer in a vehicle train; GB2540346B2015 Jul. 08 2021 Feb. 17 Haldex Brake Prod Ab Vehicle braking system; GB201611713D02016 Jul. 05 2016 Aug. 17 Haldex Brake Prod Ab Vehicle braking system; EP3967561A1 2020 Sept. 11 2022 Mar. 16 Haldex Brake Products Aktiebolag Commercial vehicle trailer compressed air system; EP3967562A12020 Sept. 11 2022 Mar. 16 Haldex Brake Products Aktiebolag Compressed air device for a trailer

Related family citations include CN106627547B2016-11-172019-01-29 Electronic brake system, method for vehicle starting and automatic parking function; DE102019106274A12019-03-122020-09-17 Wabco Gmbh Electronically controllable braking system with two fall-back levels (alternative version); GB2583723B2019-05-032023-07-05 Knorr Bremse Systeme Fuer Nutzfahrzeuge Gmbh Trailer braking system; GB2583533B2019-05-032023-02-01 Knorr Bremse Systeme Fuer Nutzfahrzeuge Gmbh Trailer braking system; US11518349B22019-06-062022-12-06Caterpillar Inc. Automatic break application for emergency stop; DE102019127727A1 2019-10-152021-04-15 Knorr-Bremse Systeme für Nutzfahrzeuge GmbH Device and method for controlling a brake system of a trailer of a vehicle combination from a towing vehicle of the vehicle combination, control system for controlling a brake system of a vehicle combination and towing vehicle for a trailer; DE102019130762A12019-11-142021-05-20 Wabco Europe Bvba Electropneumatic control module; DE102020124225A12020-09-172022-03-17 Zf Cv Systems Europe Bv-Valve arrangement of a towing vehicle for controlling a pneumatic brake system of a trailer vehicle and method for controlling it; JP7327364B22020-11-272023-08-16 brake system; DE102021117212A12021-07-052023-01-05 Zf Cv Systems Global Gmbh Choosing a trailer for a transport; CN113479175B2021-08-232022-07-12 Braking system device of self-propelled fire control trailer; DE102022101141A12022-01-192023-07-20 Zf Cv Systems Global Gmbh Electro-pneumatic trailer parking brake system, trailer, combination; DE102022204480A12022-05-062023-11-09 Zf Friedrichshafen Ag Actuation system for a vehicle brake; DE102022114280A12022-06-072023-12-07 Zf Cv Systems Global Gmbh Method and device for safely braking a trailer; GB2621120A2022-07-292024-02-07Haldex Brake Prod Ab A trailer braking system; DE102017118529B42019-05-29 Electronically controlled trailer brake control unit and trailer brake system; EP3600991B12021-09-29Electro pneumatic hand brake with integrated tcv; EP3600981B12023-08-02Electropneumatic hand brake (eph) having integrated tcv; EP1504975B12007-03-21Brake system for a vehicle using a pressure medium; EP2121397B12013-05-01Parking brake module for a pressure medium-operated brake system; EP2754594B12016-07-27Method and device for controlling a compressed air braking system of a vehicle combination; EP2939892B12018-11-14 Electric parking brake for a vehicle; EP3515770B12020-07-08 Parking brake valve device for actuating a spring-type parking brake; DE102012101871B42013-12-12 Parking brake valve device and pneumatic trailer air brake system; EP4069559B12025-01-08 Monostable and fault-tolerant parking brake valve assembly; DE102013106260B42022-05-25 Electropneumatic braking system; W01997032767A11997-09-12 Trailer control valve for a motor-vehicle compressed-air brake system; WO2015154787A12015-10-15 Electro-pneumatic parking brake control device; EP3967561B12024-10-30 Commercial vehicle trailer compressed air system; EP2570316B12016-03-30 Compressed air supply device for a commercial vehicle; EP0547407B11996-03-06 Compressed air brake system, especially for commercial vehicles; DE102011053707A12013-03-21 Compressed air conditioning unit; EP3749558B12023-06-07 Braking system for a utility vehicle, compressed air processing unit, and use of a compressed air processing unit; EP2368778A22011-09-28 Brake control system of a mobile work machine, in particular industrial truck; EP3967562B12023-12-13 Compressed air device for a trailer; EP4259498A12023-10-18 Compressed-air braking system for a tractor vehicle; W02023138927A12023-07-27 Operationally reliable parking brake valve assembly comprising multiway switching in series; DE102017118529.1A2017-08-142017-08-14 Electronically controlled trailer brake control unit and trailer brake system; EP18186400.0A2017-08-142018-07-30 Electronically controlled trailer brake unit and trailer brake system; HUE18186400A2017-08-142018-07-30 Electronically controlled trailer brake unit and trailer brake system; PL18186400T2017-08-142018-07-30 Electronically controlled trailer brake unit and trailer brake system; andCN201810922743.2A2017-08-142018-08-14 Electronically controlled trailer brake control unit and trailer brake system.

### BACKGROUND

Heavy duty trailers used in road transportation lack security devices. Any tractor can hook to and pull trailers to anywhere. This allows costly logistics mistakes, theft, fraud and deviation from safety protocols. To prevent this, prior art teaches various methods for securing trailers. There are many patents that lie within the B6OR25 and B60R classification codes which focus on fittings or vehicle control systems for preventing or indicating unauthorised use or theft of vehicles.

Some of these describe mechanisms for blocking trailer air lines (U.S. Pat. Nos. 5,145,240; 6,338,534; 7,344,202), others describe electronic controllers that can control air lines (U.S. Pat. No. 10,858,053).

These mechanisms are external to the brake unit itself, and therefore can be bypassed by installing a parallel line to the brake chamber or disc actuator, or by caging the parking spring. None of the prior art citations herein teach or disclose methods or devices for preventing tampering of air brake chamber immobilization devices described in this invention.

There is thus a need for a mechanism that cannot be bypassed without significant risk to bodily injury and/or substantial alteration to trailer systems. The present invention teaches a novel device that prevents bypassing by integrating digital security features in the brake unit itself. This integration is not taught in the prior art.

### SUMMARY

Certain features, aspects and examples disclosed herein are directed to an electro-mechanical device that prevents the compression of the brake spring. Certain features, aspects and examples disclosed herein are directed to a device that prevents access to the caging mechanism of the brake spring. Certain features, aspects and examples disclosed herein are directed to a mechanism for automatically engaging the brake spring. Other features, aspects and examples disclosed herein are directed to a system, method and device for controlling the aforementioned devices and mechanism through verification of authorization of desired driver operations. Additional features, aspects and examples are discussed in more detail herein.

### BRIEF DESCRIPTION OF THE DRAWINGS

In order to facilitate a fuller understanding of the present invention, reference is now made to the accompanying drawings. These drawings should not be construed as limiting the present invention but are intended to be illustrative only. FIG. 1 is an exemplary embodiment of a double-diaphragm style spring brake with electronic control chamber 100 inside the casing. The control chamber houses an electronic control module 101 and an electric ball valve actuator 102. The valve opens or seals off supply line 103 to control air flow into the spring side. 105 is a solenoid which controls a conical spindle 106 to block access to the caging hole. 107 and 108 are solenoids for venting air outside the chamber directly to the atmosphere or through the service side. 104 is a control and power supply cable running from 101 to all electrical components. 104 lines the inner walls and passes through channels in the casing to reach other sides of the chamber.

FIG. 2 is a block diagram of an embodiment of the electronic control module 101, comprised of motion and location sensors that gives the authorization module 201 situational awareness. Authorization module 201 is communicatively coupled to inlet controller 212 which electrically controls the ball valve actuator 102 via the electrical interface 211. Similarly, the vent controller 222 electrically controls the solenoids 107 and 108 through the interface 221. The caging controller 232 electrically controls the solenoid 105 through the interface 231.

FIG. 3 is an exemplary embodiment of a conical spindle 106. Therein, 300 is a solenoid control which linearly moves the shaft 301. The shaft is connected to the conical spindle via a bearing such that the spindle rotates freely about the shaft. In the blocked position, the spindle is aligned with the caging bolt hole. The free rotating motion prevents sabotage via drilling. When actuated, the shaft retracts the spindle to unblock access.

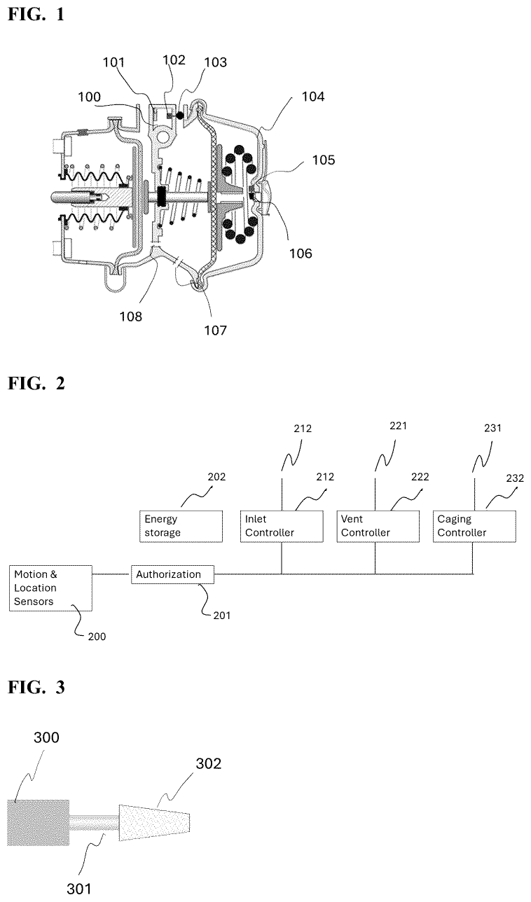

1. An air brake chamber device integrating at least or one mechanism for blocking spring side pressurization, venting pressurized air or preventing caging the parking spring, wherein:
at least one of the integrated mechanisms is controlled by an electronic device capable of granting access by verifying access credentials.

2. A device as claimed in claim 1, wherein at least one component of the electronic device is integrated in or on the brake chamber.

3. A device as claimed in claim 2, wherein components outside the brake chamber are communicatively coupled to components integrated in the chamber via encrypted channels.

4. A device as claimed in claim 2, wherein integrated electronic components can be powered through a brake-chamber integrated energy storage device.

5. A device as claimed in claim 1, wherein the electronic device can engage the parking brake independent of driver action.

6. A device as claimed in claim 1, wherein the electronic device processes location, time and motion information, and wherein the processed information may activate at least one of the three mechanisms in claim 1.

7. A device as claimed in claim 1, wherein the electronic device processes data elements to grant access to release the parking brake or to compress the parking spring, wherein the data elements comprise at least one of identifying information of the driver, the tractor, or access code.

8. A device as claimed in claim 7, wherein the data element is received by the device from at least one of an upstream computing system not located on the same vehicle.

9. A device as claimed in claim 7, wherein the data element is received by the device from an input device installed on the same vehicle.
